(19) United States
(12) Patent Application Publication
(10) Pub. No.: US 2006/0111492 A1
(43) Pub. Date: May 25, 2006

(54) Use of polar-modified polyolefin waxes to improve adhesion of sealants to powder coatings

(75) Inventors: DI. Manfred Schmalzl, Karlsfeld (DE); Hans-Dieter Nowicki, Gersthofen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 11/286,525

(22) Filed: Nov. 23, 2005

(30) Foreign Application Priority Data
Nov. 25, 2004 (DE) 10 2004 056 875.8

(51) Int. Cl. C08L 91/06

(52) U.S. Cl. 524/275

(57) ABSTRACT

The invention relates to the use of polar-modified polyolefin waxes to improve the adhesion of sealants to powder coatings.

The present invention is described in the German priority application No. 102004056875.8, filed 25.11.2004, which is hereby incorporated by reference as is fully disclosed herein.

The invention relates to the use of polar-modified polyolefin waxes to improve the adhesion of sealants to powder coatings.

Solvent-free, pulverulent coating systems, known as powder coatings, are increasingly gaining in importance. These powder coating materials are applied generally by electrostatic means to substrates, and are cured at relatively high temperatures.

The use of waxes based on polyethylene, polypropylene, polytetrafluoroethylene, bisstearoylamide, and montanic acids as additives to improve scratch resistance, degassing behavior or pigment dispersing for such systems is a traditional component of the art.

In the context of the use of powder-coated parts, transitions to other objects or components are frequently sealed using sealants based on silicone or acrylate. A disadvantage of the waxes known and used to date is that they lower, or even entirely negate, the adhesion of sealants to the powder-coated surface.

The invention is therefore directed to the use of polyolefin waxes modified such that they avoid the aforementioned disadvantages and allow the adhesion of sealants to be improved.

The aforementioned object is consequently solved by the use of polar-modified polyolefin waxes to improve the adhesion of sealants to powder coatings.

These polar-modified polyolefin waxes are preferably prepared by grafting polyolefin waxes with polar graft comonomers.

The polar graft comonomers are preferably alpha,beta-unsaturated carboxylic acids and/or their derivatives and/or alkoxyvinylsilane.

The fraction of the polar graft comonomer, based on grafted polyolefin wax, is preferably 0.1% to 20% by weight.

The polyolefin wax is preferably polyethylene, polypropylene or an ethylene-propylene copolymer.

The melt viscosities of the grafted polyolefin waxes are preferably 10 to 50 000 mPas, measured at 170° C., and their softening points (ring & ball) are preferably 75 to 170° C.

The melt viscosities of the grafted polyolefin waxes are more preferably 40 to 30 000 mPas, measured at 170° C., and their softening points (ring & ball) are more preferably 80 to 160° C.

The polar-modified polyolefin waxes are preferably used, based on the total weight of the powder coating materials, in amounts of 0.1 to 20.0% by weight.

The polar-modified polyolefin waxes are more preferably used, based on the total weight of the powder coating materials, in amounts of 0.1 to 10.0% by weight.

The polar-modified polyolefin waxes are in particular used, based on the total weight of the powder coating materials, in amounts of 0.3 to 6.0% by weight.

The polar-modified polyolefin waxes are preferably used with customary additives such as crosslinking agents, crosslinking accelerators, pigments, UV stabilizers, and other auxiliaries.

The invention also relates to powder coating materials comprising thermoplastic or thermosetting synthetic resins and, based on the total weight of the powder coating materials, 0.1 to 20.0% by weight, preferably 0.3 to 6.0% by weight, of one or more polar-modified polyolefin waxes, the polar-modified polyolefin waxes being prepared by grafting polyolefin waxes with polar graft comonomers, and further comprising, if desired, customary additives such as crosslinking agents, crosslinking accelerators, pigments, and UV stabilizers.

The abovementioned polyolefin waxes which can be used are obtainable by processes as described in Ullmanns Encyclopädie der technischen Chemie, 5th edition, vol. A28, page 107 and pages 146-155, Verlag Chemie Weinheim (ISBN 3-527-20128-9), 1991, and also in EP-A-0 321 852, EP-A-0 384 264, EP-A-0 416 566 and DE-A-196 48 895.

Grafting is carried out in the manner as described for example in EP-A-0 941 257 or in JP-A-54/145785.

Suitable starting material for the grafting operation are polyolefins having melt viscosities of 10 to 50 000 mPas, measured at 170° C., and softening points (ring & ball) of 75 to 170° C., preferably of 80 to 160° C.

Suitable polar graft comonomers are α,β-unsaturated carboxylic acids or their derivatives or alkoxyvinylsilanes of the general formula CH₂═CR¹—(COO)ₓ(CₙH₂ₙ)_{y}Si(R²)_{z}(OR³)_{3-z}, where R¹ is hydrogen or CH₃ and R² and R³ are branched or unbranched alkyl radicals having 1 to 6 carbon atoms, n=1 to 6, x and y=0 or 1, where y=1 if x=1, and z=0 to 2.

Particular preference is given to vinyltrimethoxysilane or vinyltriethoxysilane.

Examples of α,β-unsaturated carboxylic acids or their derivatives are acrylic acid or methacrylic acid or their esters or amides, maleic acid, maleic anhydride, monoesters or diesters of maleic acid, and amides of maleic acid. Preference is given to maleic acid and its derivatives; maleic anhydride is particularly preferred.

The fraction of the polar graft comonomers relative to polyolefin is 0.1 to 20% by weight. Grafting can be carried out in one step or in two or more steps. One or more graft comonomers can be used for grafting.

In accordance with the invention, therefore, polar-modified polyolefin waxes can be used as additives to improve the adhesion of sealants in powder coating materials.

The subject matter of the present invention is applicable to standard types of powder coatings, such as are described in Ullmanns Encyclopädie der technischen Chemie, 5th edition, vol. A18, pages 438-444, Verlag Chemie Weinheim, 1991.

### EXAMPLES

Physical Properties of the Polar Polyolefin Waxes Tested

| | | % | | Approximate | | Approximate |
|---|---|---|---|---|---|---|
| | | polar | Polar | viscosity at | | softening point |
| | Type/process | component | component | 170° C. | | (ring & ball) |
| Wax 1¹⁾ | polypropylene wax by | 7 | maleic | 800 | mPas | 156° C. |
| | Ziegler process | | anhydride | | | |
| Wax 2¹⁾ | polypropylene wax by | 7 | maleic | 10 | mPas | 140° C. |
| | metallocene process | | anhydride | | | |
| Wax 3¹⁾ | polyethylene wax by | 7.5 | maleic | 100 | mPas | 120° C. |
| | metallocene process | | anhydride | | | |
| Wax 4²⁾ | polyethylene wax by | 10 | trimethoxy- | 60 | mPas | 115° C. |
| | metallocene process | | vinylsilane | | | |
| Wax 5 | polyethylene wax by | 0 | — | 200 | mPas | 125° C. |
| (comparative) | Ziegler process | | | | | |

¹⁾Prepared in accordance with EP-A-0 941 257
²⁾Prepared in accordance with JP-A-54/145785

To test the suitability of the polar polyolefin waxes used in accordance with the invention to improve the adhesion of sealants, they were tested in the following powder coating systems:

1. Polyester-Epoxide Coating Material

A powder coating composition composed of 39.5 parts by weight of a carboxy-functional polyester resin, 16.7 parts by weight of an epoxy resin, 3.0 parts by weight of a flow control additive, 0.3 part by weight of a degassing agent, 10.0 parts by weight of a filler, and 29.5 parts by weight of titanium dioxide was mixed in a high-speed mixer with the addition of 1.0 part by weight of the test polar polyolefin wax of the invention; the mixture was subsequently extruded at about 100° C., pelletized, ground, and sieved. The resulting powder coating materials were applied electrostatically to a metal surface and baked at 180° C. for 15 minutes.

2. Polyester Coating Material

In a procedure similar to that described under 1, a powder coating material was prepared from 60.4 parts by weight of a carboxy-functional polyester resin, 4.5 parts by weight of triglycidyl isocyanurate, 3.2 parts by weight of a flow control additive, 0.5 part by weight of a degassing agent, 10.0 parts by weight of a filler, and 20.4 parts by weight of titanium dioxide, with the addition of 1.0 part by weight of a polar polyolefin wax of the invention, and this coating material was applied to a metal surface. The baking conditions are 15 minutes at 180° C.

Standard commercial silicone sealant (e.g., Knauf Bau-Silikon, white, for interior and exterior use) was applied to the powder-coated surfaces from a cartridge in accordance with the instructions. The ultimate strength of the sealant is attained after 6 to 8 days. When this ultimate strength had been attained an attempt was made to remove the applied sealant by hand. In the case of the powder coating both without wax additive and with the comparative wax (wax 5), the sealant could be removed readily, without residue, and without cohesive fracture.

From the powder coatings containing the polar polyolefin waxes of the invention, from Examples 1 to 4, the silicone sealant could not be removed without destruction. Consequently the adhesion of sealants to powder coatings is improved using polyolefin waxes which have undergone polar modification in accordance with the invention.

1. A method for improving the adhesion of sealants to powder coatings comprising the step of adding at least one polar modified polyolefin wax to the powder coating during the production of the powder coating.

2. The method as claimed in claim 1, wherein the at least one polar-modified polyolefin wax is prepared by grafting the polyolefin wax with at least one polar graft comomoner.

3. The method as claimed in claim 1, wherein the polar graft comonomers are selected the from the group consisting of alpha,beta-unsaturated carboxylic acids derivatives of alpha,beta-unsaturated carboxylic acids and alkoxyvinylsilane.

4. The method as claimed in claim 2, wherein the fraction of the at least one polar graft comonomer, based on the at least one grafted polyolefin wax, is 0.1 to 20% by weight.

5. The method as claimed in claim 1, wherein the at least one polyolefin wax is polyethylene, polypropylene or an ethylene-propylene copolymer.

6. The method as claimed in claim 1, wherein the melt viscosities of the at least one polar modified polyolefin wax is 10 to 50 000 mPas, measured at 170° C., and the softening point (ring & ball) of the at least one polar modified polyolefin wax is 75 to 170° C.

7. The method as claimed in claim 1, wherein the melt viscosity of the at least one polar modified polyolefin wax is 40 to 30 000 mPas, measured at 170° C., and the softening point (ring & ball) of the at least one polar modified Polyolefin wax is 80 to 160° C.

8. The method as claimed in claim 1, wherein the at least one polar-modified polyolefin wax is used, based on the total weight of the powder coating material, in an amount of 0.1% to 20.0% by weight.

9. The method as claimed in claim 1, wherein the at least one polar-modified polyolefin wax is used, based on the total weight of the powder coating material, in an amount of 0.1% to 10.0% by weight.

10. The method as claimed in claim 1, wherein the at least one polar-modified polyolefin wax is used, based on the total weight of the powder coating material, in an amount of 0.3% to 6.0% by weight.

11. The method as claimed in claim 1, wherein the at least one polar-modified polyolefin wax further comprises at least additive selected from the group consisting of crosslinking agents, crosslinking accelerators, pigments and UV stabilizers.

12. A powder coating material comprising at least one thermoplastic or thermosetting synthetic resin and, based on the total weight of the powder coating material, 0.1 to 20.0% by weight, of one or more polar-modified polyolefin waxes, the one or more polar-modified polyolefin waxes being prepared by grafting one or more polyolefin waxes with at least one polar graft comonomer.

13. The powder coating material as claimed in claim 12, wherein the one or more polar-modified polyolefin waxes are present, based on the total weight of the powder coating material, in an amount of 0.3 to 6.0%.

14. The powder coating material as claimed in claim 12, wherein the one or more polyolefin waxes further comprises at least one additive selected from the group consisting of crosslinking agents, crosslinking accelerators, pigments and UV stabilizers.
